(19) United States
(12) Patent Application Publication
(10) Pub. No.: US 2005/0148717 A1
(43) Pub. Date: Jul. 7, 2005

(54) Phosphorescent light cover or coating

(76) Inventors: James Smith, Pleasanton, CA (US); John Clear, Victoria (AU)

Correspondence Address: WELSH & KATZ, LTD, 120 S RIVERSIDE PLAZA, 22ND FLOOR, CHICAGO, IL, 60606, US

(21) Appl. No.: 10/516,965

(22) PCT Filed: Jun. 4, 2003
(86) PCT No.: PCT/AU03/00695

(30) Foreign Application Priority Data
Jun. 4, 2002 (US) 60385627

(51) Int. Cl. C08K 3/30; C08K 3/10

(52) U.S. Cl. 524/418; 524/436

(57) ABSTRACT

The invention relates to phosphorescent light covers (1) and coatings that, following illumination from a light source (2) will luminesce over a period of time after illumination from the light source has ceased. A phosphorescent light covering (1) or coating is adapted to be retained or located on or about a light source (2), the cover (1) or coating comprising a base material and one or more phosphorescent compounds. The cover (1) may be in the form of a sleeve (1) adapted to encompass a fluorescent globe (2), part or all of which allows light transmission, the light cover (1) further comprising friction fit end pieces (3) having an aperture or apertures (8) through which connection pins (9) may penetrate.

### FIELD OF THE INVENTION

The present invention relates to phosphorescent light covers and coatings and in particular to light covers and coatings that following illumination from a light source will luminesce over a period of time after illumination from the light source has ceased. The invention also relates to processes of producing phosphorescent light covers and coatings.

### BACKGROUND OF THE INVENTION

Modern homes, businesses and public buildings are extremely reliant upon electricity for light generation. This reliance can become problematic and potentially hazardous in situations where building security or occupant safety is threatened. For example, in the case of a fire, an explosion, earthquake or other natural disaster or in the case of attack by armed forces, terrorists, rioters or thieves it may well be the case that the building electrical supply is either deliberately or accidentally disconnected. Although modem building codes require a level or lighting and directional indication to assist in an evacuation situation, which must be run from an alternative power circuit, such alternative lighting systems are prone to failure during an evacuation situation as a result of poor maintenance, sabotage or the impact of fire, a natural disaster or an explosion. It is also desirable in buildings where cash or other valuables are kept for fail safe security lighting to be provided as a means of deterring and/or detecting security breaches, theft or looting. It is with these issues in mind that the present invention has been conceived.

The present invention offers a means of providing lighting that may improve building security, offer after hours lighting and assist in the situation where evacuation is required, by relying upon phosphorescence that utilises energy from existing light sources. The present invention may have particular utility as back-up safety lighting in potentially dark and/or dangerous work places and facilities, such as mines, factories, power stations, aircraft, ships, boats or submarines, hospitals, bunkers and the like. The invention may also be useful as an energy saving device, where the luminescent light is utilised instead of mains electricity to provide low level after-dark or after hours lighting.

### SUMMARY OF THE INVENTION

According to one embodiment of the present invention there is provided a phosphorescent light cover or coating adapted to be retained or located on or about a light source, said cover or coating comprising a base material and one or more phosphor compounds. Part or all of the cover or coating may allow light transmission. Alternatively, part or all of the cover or coating may be light reflective.

The base material may, for example, comprise glass, plastic, a fabric or mesh. The plastic may for example be selected from one or more of polyethylene, polytetrafluoroethylene, polypropylene, poly(4-methylpentene-1), poly(tetrafluoroethylene), polyvinylchloride, polystyrene, polymethylmethacrylate, a polyurethane, a polycarbonate, a polysiloxane or poly(2,6-dimethylphenylene oxide).

In one embodiment of the invention the phosphor compound may be selected from one or more of strontium aluminate, alkaline earth metal sulphide, alkaline earth metal silicate oxide and zinc sulphide. The phosphor compound may for example be europium doped and/or copper activated.

The phosphorescent light cover or coating may take a variety of different forms such as being integral to a light bulb, being in the form of a coating applied to a light bulb, being in the form of a coating applied to a light bulb cover, being in the form of a paint, lacquer, varnish or a polymeric film, being in the form of an incandescent light cover, being in the form of a fluorescent light cover or a light shade, for example. The fluorescent light cover or coating may comprise a lens or may be in the form of a sleeve adapted to encompass at least a lengthwise portion of a fluorescent globe. In the case of a sleeve it is preferred that it encompass substantially all of the fluorescent globe. The sleeve may be provided with friction fit end pieces having an aperture or apertures through which fluorescent globe connection pins may penetrate.

According to another embodiment of the invention there is provided a phosphorescent light cover comprising a base material and one or more phosphor compounds, which is in the form of a sleeve adapted to encompass a fluorescent globe, part or all of which allows light transmission, the light cover further comprising friction fit end pieces having an aperture or apertures through which fluorescent globe connection pins may penetrate. The sleeve may preferably be produced from a plastic, such as the plastics recited above, most preferably from polypropylene and the phosphor compound may similarly be selected from those recited above, most preferably strontium aluminate.

According to a further embodiment of the present invention there is provided a process for producing a phosphorescent light cover sleeve adapted to encompass at least a lengthwise portion of a fluorescent globe, comprising the steps of:
(a) mixing an extrudable or mouldable plastic with at least one phosphor compound to produce a master batch material;
(b) moulding or extruding the master batch material under appropriate temperature conditions to form a light cover sleeve of desired dimensions. Preferably the master batch material is in the form of pellets or granules and preferably the moulding or extruding is carried out at a temperature of between about 180° C. to about 230° C., more preferably between about 200° C. to about 210° C. and most preferably at about 205° C. Preferably the master batch material is extruded.

### BRIEF DESCRIPTION OF THE FIGURES

FIG. 1 shows a perspective view of a phosphorescent light cover according to the invention that is adapted to encompass a fluorescent globe.

### DETAILED DESCRIPTION OF THE INVENTION

The reference to any prior art in this specification is not, and should not be taken as, an acknowledgment or any form of suggestion that that prior art forms part of the common general knowledge in Australia.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

As indicated above, in the broadest aspect of the present invention there is provided a phosphorescent light cover or coating adapted to be retained or located on or about a light source, which is comprised of a base material and one or more phosphor compounds. By the term “phosphorescent” it is intended to convey that luminescent visible light emanates from the light cover or coating after it has been exposed to light emanating from the light source for a period suitable to excite the phosphor compound, such that the luminescent light is produced for a period of time after the light source has ceased emitting light. While the light covers or coatings according to the invention may emit some fluorescent light at or shortly after the time of light exposure from the light source, the main focus of the invention is in the emission of phosphorescent light that takes place a period of time after exposure to light from the light source has ceased. As will be readily understood the amount of phosphorescent light generated will depend upon the nature and amount of phosphor compound incorporated within the light cover or coating and the intensity and duration of prior light exposure. For example, however, the present inventors have determined that it is possible to produce light covers or coatings according to the invention that will emit a level of phosphorescent light detectable to the human eye in an otherwise darkened room for a period of up to 30 hours after the original light exposure has ceased.

The light covers or coatings according to the invention may take a variety of different forms, but at their simplest level they will include at least a base material and a phosphor compound. The base material provides the substance or matrix of the light cover or coating and may consist of a single compound or component or a mixture or combination of compounds or components. For example, in one embodiment of the invention the base material comprises glass or plastic which can be extruded, moulded or otherwise shaped to a desired configuration. In another embodiment of the invention the base material may comprise a fibre, woven material or fabric, and it is even possible for the base material to take the form of a mesh of polymer or metallic material or a coating that may be applied in the form of a film or as a liquid, such as a paint, lacquer or varnish. While the nature of the base material can vary widely and can constitute one or many components accordingly, it is important that there is either incorporated therein or applied thereto at least one phosphor compound.

Phosphor compounds suitable for use in the present invention are those compounds known to emit phosphorescent light in the visible wavelength range after exposure to a light source. Examples of suitable phosphor compounds, which are all readily commercially available, include the alkaline earth metal sulphides, alkaline earth metal silicate oxides and more particularly zinc sulphide and strontium aluminate. Strontium aluminate is a particularly preferred phosphor compound as it is energised by visible and UV light and it exhibits a significant persistence, that is the period of time over which it emits light following cessation of the energising light exposure. As is well understood in the art some advantages may be obtained by adopting a phosphor compound that is doped with europium, particularly strontium aluminate when europium doped, and it may also be advantageous for the phosphor to include an activator compound, such as a copper activator. A copper activator is commonly adopted in relation to the use of zinc sulphide as a phosphor compound.

The light cover or coating according to the invention, in whatever form it takes, is adapted to be retained or located on or about a light source. The importance of this feature of the invention is that it will allow the light cover or coating to receive direct light emitted from the light source and to thereby maximise energisation of the phosphor compound incorporated therein. The other advantage of being located on or adjacent to the light source is that lights are usually installed in a position to illuminate the intended local area, and in this way the phosphorescent light emanating from the light cover or coating will similarly be directed to an area where lighting is required. The adaptation to be retained or located in close association with the light source may take a variety of forms, once again depending upon the nature of the light cover or coating. For example, in the case where the coating comprises a film to be applied to a light globe or to an existing light cover or light fitting component, the film may preferably be provided with an adhesive to allow application and retention of the coating. Similarly, in the case of a paint, lacquer or other liquid coating that may similarly be applied directly to a light globe, an existing light cover or light fitting component, the very nature of the paint, lacquer or varnish will allow application and retention of the coating in close association with the light source. As will be well understood by a person skilled in the art it will be important that the base materials, eg. fillers, binders, solvents, etc. included in the coating are compatible with the materials to which they are intended to be applied, and are physically suited to an environment likely to be exposed to relatively high temperature over sustained periods.

In the case of a light cover that is in fact incorporated within light transmissive material of a light bulb, this very nature of the light cover provides its adaptation for close association with the light source. In other embodiments of the invention the light cover may comprise a component of a light fitting, preferably one through which light is intended to be transmitted, which replaces an existing component. Examples of such components include covers, lenses, troffers and shades associated with fluorescent or incandescent light globes. The benefit of this approach to the invention is that the light cover will not require the use of a special fitting or bracket but can utilise existing components of the light fitting to be held in the appropriate location. This may similarly be the case where the light cover or coating is in the form of a reflector or a component of a reflective material (eg. the glass in front of a metallic mirror surface) that is located behind or adjacent to a light source.

It is also possible, however, for the light cover of the invention to take the form of an additional component that may be added to an existing light fitting. In this instance the cover may take a form that allows it to be placed and retained around or adjacent to the light source, as an additional component. It may be necessary for conventional brackets, clips or fasteners to be utilised to retain the cover, although preferably the cover can be shaped to fit with existing light fitting components such that a specialised clasping or retaining component is not required.

In preferred embodiments of the invention the light cover or coating is provided in such a manner as to encompass the light source such that the material that comprises the light cover or coating allows light transmission therethrough. This may for example be by virtue of the nature of the material itself or by virtue of the configuration of the material which allows light to pass through gaps or voids. It is also possible for the light cover to take a form such that only a portion of the light emanating from the light source penetrates therethrough. In this context the phosphorescent light cover or coating may form only a partial cover of the light source. This could in effect be achieved either by the physical configuration of the cover or by virtue of the location within the cover of only bands, strips or segments, for example, of the phosphor compound. In the case of a coating therefore the coating may be applied only in strips or bands to the light globe or light fitting component and in the case of an extruded cover this outcome could be achieved by co-extrusion or by assembly of parts some of which include a phosphor compound and some of which do not. Similar approaches may be taken to incorporate indicia such as warnings or directional indicators within the covers or coatings. Standard printing and signage approaches may also be adopted.

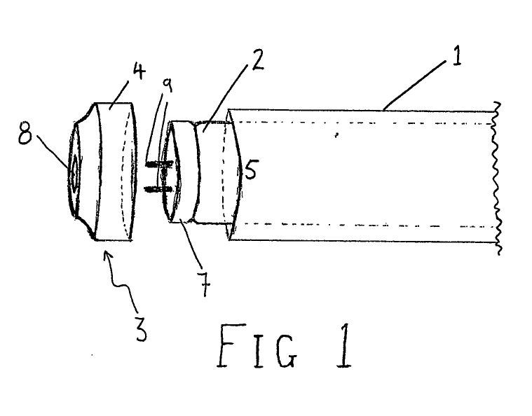

In a particularly preferred embodiment of the invention, an exemplary form of which is shown in FIG. 1, the phosphorescent light cover comprises a sleeve configured to encompass and contain a fluorescent globe. The sleeve is preferably of cylindrical configuration and may encompass a lengthwise portion of the fluorescent globe, or indeed substantially the full length of the globe. It is also possible for the sleeve to be configured such that it covers only a portion or segment of the circular cross section of the fluorescent globe, although in this case it may be necessary for brackets or fastening means to be provided.

In the preferred embodiment of the phosphorescent light sleeve for a fluorescent globe shown in FIG. 1 the sleeve 1 encompasses substantially the full length of the fluorescent globe 2. In the case of the sleeve 1 shown in FIG. 1 the sleeve is produced from plastic into which the phosphor compound has been incorporated prior to shaping. As will be readily understood shaping of plastics materials of this type can readily be achieved by utilising conventional extrusion, moulding or blow moulding procedures. For example, plastics utilised in both this and other forms of the invention may comprise one or more of polyethylene, polytetrafluoroethylene, polypropylene, poly(4-methylpentene-1), poly(tetrafluoroethylene), polyvinylchloride, polystyrene, polymethylmethacrylate, a polyurethane, a polycarbonate, a polysiloxane or poly(2,6-dimethylphenylene oxide). The plastics may be thermoplastics or more preferably thermosetting plastics. In a particularly preferred embodiment of the invention polypropylene may be utilised.

As also shown in FIG. 1 the phosphorescent light cover for a fluorescent tube may include an end piece 3, preferably located at each end of the fluorescent globe. The end piece shown in FIG. 1 is a friction fit component by virtue of the sizing of the rim section 4 which fits snugly over the end section 5 of the sleeve 1. It is also preferred that the end section 3 includes a narrower neck 6 sized to snugly friction fit about the contact end 7 of the fluorescent globe 2. There is also provided one or more apertures 8 within the end piece 3 to allow penetration therethrough of the fluorescent globe connection pins 9.

The benefit of utilising an end piece in conjunction with the fluorescent globe light sleeve is that the sleeve may be maintained at a standardised distance from the fluorescent globe along the length of the globe. This allows temperature within the globe and within the sleeve to be maintained relatively constant throughout, for optimal performance of the globe and optimal energisation and subsequent phosphorescence of the light sleeve. The present inventors have determined that optimal performance is achieved when a blanket of air from between about 0.5 mm to about 10 mm, preferably between about 0.1 mm to about 5 mm is provided between the globe and the sleeve. Preferably, the separation is approximately 2 mm when the sleeve is configured for use in conjunction with a standard T-8,1″ diameter, 34 watt fluorescent globe, of 48″ in length.

Naturally, the fluorescent globe light sleeve according to the invention can be configured for use with all types of fluorescent globes, specifically also including the T-12, 1½″ diameter, 40 watt globe type. It will also be understood that phosphorescent light covers or coatings according to the present invention can be adopted in conjunction with all manner of other light sources including incandescent lights of various shapes, fitting types and wattages. As it is the case, especially in conjunction with fluorescent globes, that a low level of ultraviolet radiation is emitted in conjunction with visible white light, and because this ultraviolet radiation is especially useful in energising phosphor compounds, and particularly strontium aluminate, it is useful for optimal energisation of the phosphor for the light cover or coating to be closely adjacent to the light source. Preferably therefore the light cover or coating will be located between about 0.01 mm to about 20 cm from the light source, most preferably between about 0.5 mm and about 10 cm, preferably between about 1 mm and about 5 cm from the light source, for standard domestic and commercial type lighting, depending upon the illumination power.

Phosphorescent light covers according to the present invention that are produced utilising plastic materials can be produced by initially creating a master batch material by mixing of the raw plastic and phosphor compound, optionally with other conventional components. Production of the master batch may result in formation of phosphor compound impregnated plastic in the form of granules or pellets which can then readily be utilised for shaping of the plastic component, for example by extrusion, moulding or blow moulding processes.

In one embodiment the master batch material can be prepared by drying the plastic, which is preferably clear (eg. polypropylene) in a temperature and humidity controlled room. The phosphor compound (eg. strontium aluminate) may be dried under similar conditions. The raw plastic material which is generally provided in a pellet form may be placed in a large mixing container, and optionally a suitable amount of conventional plasticiser agent may be added with stirring using a large paddle. A small amount of water may also be added to improve surface stickiness of the pellets. The pellet mixture may then be mixed, preferably until visual appearance indicates the pellets are coated with plasticiser and/or water. The phosphor compound may then be added in the appropriate amount depending upon the application for which the material is to be used. For example, in standard light cover applications, depending upon the intended level of luminescence, the amount of phosphor compound may vary between about 5% to about 40% by weight, however in a preferred embodiment the master batch mixture will comprise approximately 20% by weight of pigment and approximately 80% by weight of plastic, with minor amounts of other possible additives such as plasticiser, water, lubricant, binder, or the like.

Upon adding of the phosphor compound the mixture will be further mixed to coat the pellets with the phosphor compound. This batch mixture is then extruded through a conventional extrusion apparatus, under temperature conditions, approximating those utilised in the subsequent shaping extrusion step. After extrusion, preferably into long thin lengths the extruded pieces may be cut to form fine particles, for example approximately 2.3 mm in diameter. Although water may be utilised in the mixing stage of the master batching process, it is preferable during the drying of the plastic and phosphor for substantially all moisture to be removed, as failure to do so at this stage may result in reduced phosphorescence.

In one preferred embodiment of the invention where the master batch material comprises polypropylene and strontium aluminate an extrusion process to form the desired shape, for example the cylindrical sleeve as depicted in FIG. 1, may be adopted at temperatures between about 180° C. to about 230° C., preferably between about 200° C. to about 210° C., more preferably at about 205° C. In one preferred embodiment of the process heating of the master batch material takes place gradually in four separate chambers with initial heating to approximately 190° C., subsequent transition into two separate 200° C. chambers and final heating to 205° C. just prior to exposure to the extrusion die head. After extrusion the extruded piece may be cooled and cut to the desired length.

In the case of a light cover such as that depicted in FIG. 1 the end piece will preferably be produced from the same plastics material as the sleeve although the end piece need not allow light transmission and need not have phosphor compound incorporated therewithin.

It is to be recognised that the present invention has been described by way of example only and that modifications and/or alterations thereto which would be apparent to persons skilled in the art, based upon the disclosure herein, are also considered to fall within the spirit and scope of the invention.

1. A phosphorescent light cover or coating adapted to be retained or located on or about a light source, said cover or coating comprising a base material and one or more phosphor compounds.

2. The phosphorescent light cover or coating according to claim 1 wherein part or all of the cover or coating allows light transmission.

3. The phosphorescent light cover or coating according to claim 1 wherein part or all of the cover or coating is light reflective.

4. The phosphorescent light cover or coating according to claim 1 wherein the base material comprises glass.

5. The phosphorescent light cover or coating according to claim 1 wherein the base material comprises plastic.

6. The fluorescent light cover or coating according 5 wherein the plastic is selected from one or more of polyethylene, polytetrafluoroethylene, polypropylene, poly(4-methylpentene-1), poly(tetrafluoroethylene), polyvinylchloride, polystyrene, polymethylmethacrylate, a polyurethane, a polycarbonate, a polysiloxane or poly(2,6-dimethylphenylene oxide).

7. The fluorescent light cover or coating according to claim 1 wherein the material is a fabric or mesh.

8. The fluorescent light cover or coating according to claim 1 wherein the phosphor is selected from one or more of strontium aluminate, alkaline earth metal sulphide, alkaline earth metal silicate oxide and zinc sulphide.

9. The fluorescent light cover or coating according to claim 8 wherein the phosphor is europium doped.

10. The fluorescent light cover or coating according to claim 8 wherein the phosphor is copper activated.

11. The phosphorescent light cover or coating according to claim 2 which is integral to a light bulb.

12. The phosphorescent light cover or coating according to claim 2 in the form of a coating applied to a light bulb.

13. The phosphorescent light cover or coating according to claim 2 in the form of a coating applied to a light bulb cover.

14. The phosphorescent light coating according to claim 12 wherein the coating is a paint or a polymeric film.

15. The phosphorescent light cover or coating according to claim 2 in the form of an incandescent light cover.

16. The phosphorescent light cover or coating according to claim 2 in the form of a fluorescent light cover.

17. The phosphorescent light cover or coating according to claim 2 which comprises a lens.

18. The phosphorescent light cover or coating according to claim 2 in the form of a light shade.

19. The phosphorescent light cover or coating according to claim 2 in the form of a sleeve adapted to encompass at least a lengthwise portion of a fluorescent globe.

20. The phosphorescent light cover or coating according to claim 2 in the form of a sleeve adapted to encompass a fluorescent globe.

21. The phosphorescent light cover or coating according to claim 20 further comprising friction fit end pieces having an aperture or apertures through which fluorescent globe connection pins may penetrate.

22. A phosphorescent light cover comprising a base material and one or more phosphor compounds, which is in the form of a sleeve adapted to encompass a fluorescent globe, part or all of which allows light transmission, the light cover further comprising friction fit end pieces having an aperture or apertures through which fluorescent globe connection pins may penetrate.

23. The phosphorescent light cover according to claim 20 wherein the base material is a plastic.

24. The phosphorescent light cover according to claim 23 wherein the plastic is selected from one or more of polyethylene, polytetrafluoroethylene, polypropylene, poly(4-methylpentene-1), poly(tetrafluoroethylene), polyvinylchloride, polystyrene, polymethylmethacrylate, a polyurethane, a polycarbonate, a polysiloxane or poly(2,6-dimethylphenylene oxide).

25. The phosphorescent light cover according to claim 22 wherein the base material comprises polypropylene.

26. The phosphorescent light cover according to claim 20 wherein the phosphor is selected from one or more of strontium aluminate, alkaline earth metal sulphide, alkaline earth metal silicate oxide and zinc sulphide.

27. The phosphorescent light cover according to claim 20 wherein the phosphor is strontium aluminate.

28. A process for producing a phosphorescent light cover sleeve adapted to encompass at least a lengthwise portion of a fluorescent globe, comprising the steps of:
(a) mixing an extrudable or mouldable plastic with at least one phosphor compound to produce a master batch material;
(b) moulding or extruding the master batch material under appropriate temperature conditions to form a light cover sleeve of desired dimensions.

29. The process of claim 28 wherein the master batch material is in the form of pellets or granules.

30. The process of claim 28 wherein the plastic comprises one or more of polyethylene, polytetrafluoroethylene, polypropylene, poly(4-methylpentene-1), poly(tetrafluoroethylene), polyvinylchloride, polystyrene, polymethylmethacrylate, a polyurethane, a polycarbonate, a polysiloxane or poly(2,6-dimethylphenylene oxide).

31. The process according to claim 25 wherein the phosphor is selected from one or more of strontium aluminate, alkaline earth metal sulphide, alkaline earth metal silicate oxide and zinc sulphide.

32. The process according to claim 28 wherein the phosphor compound is strontium aluminate.

33. The process according to claim 28 wherein the plastic is polypropylene.

34. The process according to claim 25 wherein the phosphor compound is strontium aluminate and the plastic is polypropylene.

35. The process according to claim 34 wherein the moulding or extruding is carried out at a temperature of between about 180° C. to about 230° C.

36. The process according to claim 34 wherein the moulding or extruding is carried out at a temperature of between about 200° C. to about 210° C.

37. The process according to claim 34 wherein the moulding or extruding is carried out at a temperature of about 205° C.

38. The process of claim 34 wherein the master batch material is extruded.
